(19) United States
(12) Patent Application Publication
(10) Pub. No.: US 2008/0028043 A1
(43) Pub. Date: Jan. 31, 2008

(54) METHOD AND SYSTEM FOR PROVIDING PREFERRED MEDIA SOURCES FOR CONTENT

(75) Inventors: Zachary A. Garbow, Rochester, MN (US); Kevin G. Paterson, San Antonio, TX (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/461,184

(22) Filed: Jul. 31, 2006

(51) Int. Cl. G06F 15/16; G06F 15/173

(52) U.S. Cl. 709/219; 709/223; 709/203

(57) ABSTRACT

A method and system for providing preferred media sources of content is provided. The method includes receiving a profile of preferred content providers and corresponding uniform resource locators (URLs), each of the preferred content providers selected for a category of content. The preferred content providers are selected from a group of content providers that provide syndicated content to subscribing entities. The method also includes analyzing content feeds from the group of content providers to identify similarities in content items and to identify the categories to which each of the content items belong. The method further includes determining from the profile a preferred content provider for the category identified in response to the analyzing when a threshold level of similarities among two or more of the content items are found. The method also includes presenting the content item, which is associated with the preferred content provider and the identified category, to the subscribing entity.

### TRADEMARKS

IBM® is a registered trademark of International Business Machines Corporation, Armonk N.Y., U.S.A. Other names used herein may be registered trademarks, trademarks or product names of international Business Machines Corporation or other companies.

### BACKGROUND OF THE INVENTION

1. Field of the Invention

This invention relates to syndicated content, and particularly to a method and system for providing preferred media sources for content.

2. Description of Background

Currently there are vast numbers of content sources for all types of news, spots, weather, etc. With the proliferation of Weblogs (blogs), e.g., any news story can reach critical mass through cross-linking and track backs. In effect, almost all news can be treated as a wire story, virtually distributed to any willing outlet for publishing.

As a result many blogs and content portals provide news and links to a particular source, whereas that same article may be contained in multiple sources. For example, a blog article referencing a famous athlete may linked to the associated article at ESPN™. However, the same or very similar article may appear also on CBS Sportsline.com®, CNNSI. Com™, AOL®, etc. As a result, subscribers of news or other content feeds may easily become inundated with repetitious information.

What is needed, therefore, is a way to allow a recipient of content to control the nature and presentation of content from one or more content sources.

### SUMMARY OF THE INVENTION

The shortcomings of the prior art are overcome and additional advantages are provided through the provision of a method for providing preferred content providers for feeds of content. The method includes receiving a profile of preferred content providers and corresponding uniform resource locators (URLs), each of the preferred content providers selected for a category of content. The preferred content providers are selected from a group of content providers that provide syndicated content to subscribing entities. The method also includes analyzing content feeds from the group of content providers to identify similarities in content items and to identify the categories to which each of the content items belong. The method further includes determining from the profile a preferred content provider for the category identified in response to the analyzing when a threshold level of similarities among two or more of the content items are found. The method also includes presenting the content item, which is associated with the preferred content provider and the identified category, to the subscribing entity.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides a user interface that enables a recipient of content to control the nature and presentation of content from one or more content sources by selecting preferred content providers based upon categories of content.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram depicting a system upon which preferred content processes may be implemented in exemplary embodiments;

FIG. 2 illustrates one example of a flow diagram describing a process for implementing the preferred content processes in exemplary embodiments;

FIG. 3 illustrates one example of a computer screen window depicting a content portal web page as seen by a user; and

FIG. 4 illustrates one example of a user interface screen as seen by a user of the preferred content processes.

The detailed description explains the preferred embodiments of the invention, together with advantages and features, by way of example with reference to the drawings.

### DETAILED DESCRIPTION OF THE INVENTION

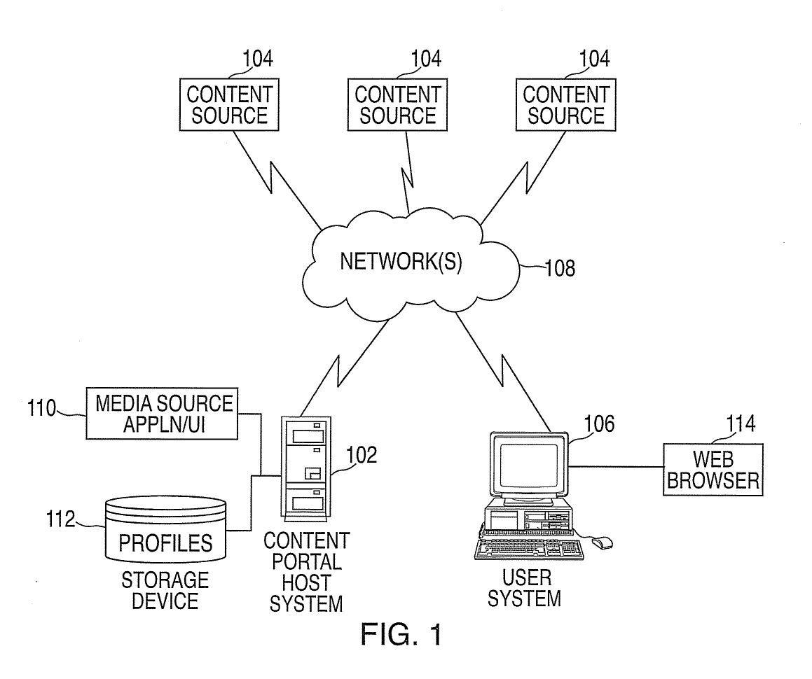

Turning now to the drawings in greater detail, it will be seen that in FIG. 1 there is a system upon which the preferred content processes may be implemented in exemplary embodiments. The system of FIG. 1 includes a content portal host system 102 in communication with content sources 104 and user system 106 over one or more networks 108. Content portal host system 102 may be implemented by a website service that provides a centralized location for access to one or more of: information, search tools, messaging, directories, shopping, advertising, blogs, etc. Content portal host system 102 (also referred to as “host system”) may be a high-speed processing device (e.g., mainframe computer) that implements a web server, applications server, etc. for providing information and services to its customers or visitors. Host system 102 is described herein as a content portal for purposes of illustration. However, it will be understood that other systems may be utilized as well (e.g., any site that links to content).

Host system 102 provides syndicated content to user systems, e.g., as a value-added service to get customers to return to the portal. The syndicated content may be implemented via a user interface that enables users to select categories of information they wish to receive content for (e.g., news, politics, weather, health, medicine, finance, sports, business, family, hobbies, etc.). Alternatively, the preferred content providers may be determined automatically by looking at which providers for various categories the user goes to already. To this end, host system 102 may also execute an aggregator tool for gathering content from various sources (e.g., content sources 104) via one or more feeds (e.g., RSS, Atom, XML, etc.) over network(s) 108. In addition, user system 106 may be a content provider (e.g., via blog software, or client-side application). In this manner, user system 106 may syndicate, or publish content over network(s) 108 to other network entities.

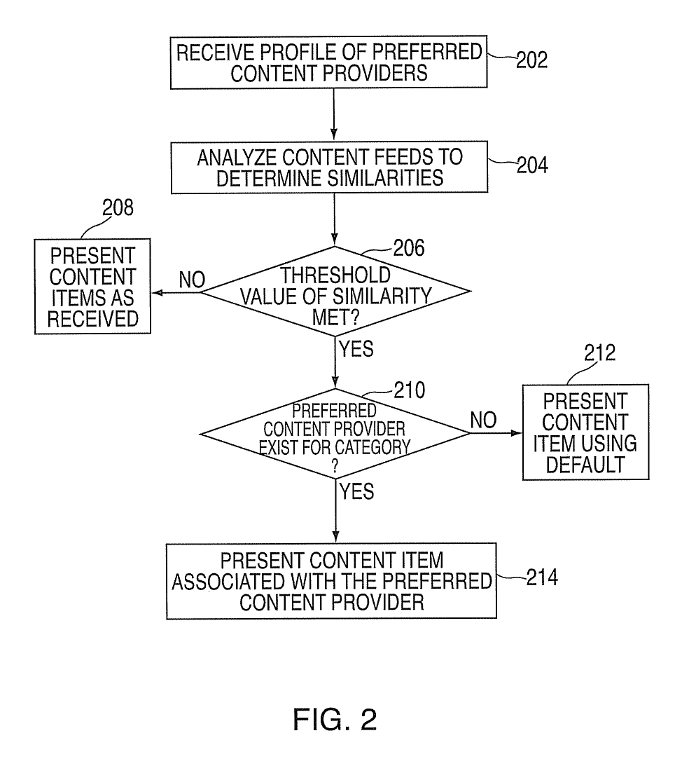

Host system 102 also executes a media source application 110 for implementing the preferred content processes. The media source application 110 includes an analysis tool for processing content received from content sources 104 as described further herein. Host system 102 is in communication with a storage device 112, either directly or via network(s) 108. Storage device 112 stores a variety of information utilized by the host system 102 including a database of profiles created via the media source application 110. Media source application 110 also includes a user interface for enabling users (e.g., user system 106) to create and modify profiles. These profiles are described further in FIGS. 2 and 4.

Content sources 104 may include any provider of content. For example, a provider of content may be a personal web page, a blog service, a podcast service, a video log service, a media website (e.g., CNN®, MSNBC®, etc.). The content is comprised of content items (i.e., each news article represents a content item; each journal entry in a blog represents a content item). Other content items may include a photograph, a video piece, a song, a television program, etc.

User system 106 may be implemented via a computer processing device, e.g., a desktop computer, laptop, portable handheld computer or cell phone, etc. User system 102 executes a Web browser application 114 and communicates with network entities, such as host system 102, via a communications service provider. A user at the user system 106, which subscribes to the syndicated content services provided by the host system 102, accesses a portal page of the host system 102 and is presented with a user interface of the media source application 110 for creating a profile as described further herein. In alternative embodiments, some or all of the functionality of the preferred content processes may be implemented directly by the user system 106 (e.g., the media source application, user interface 110 and aggregator executing on the user system 106).

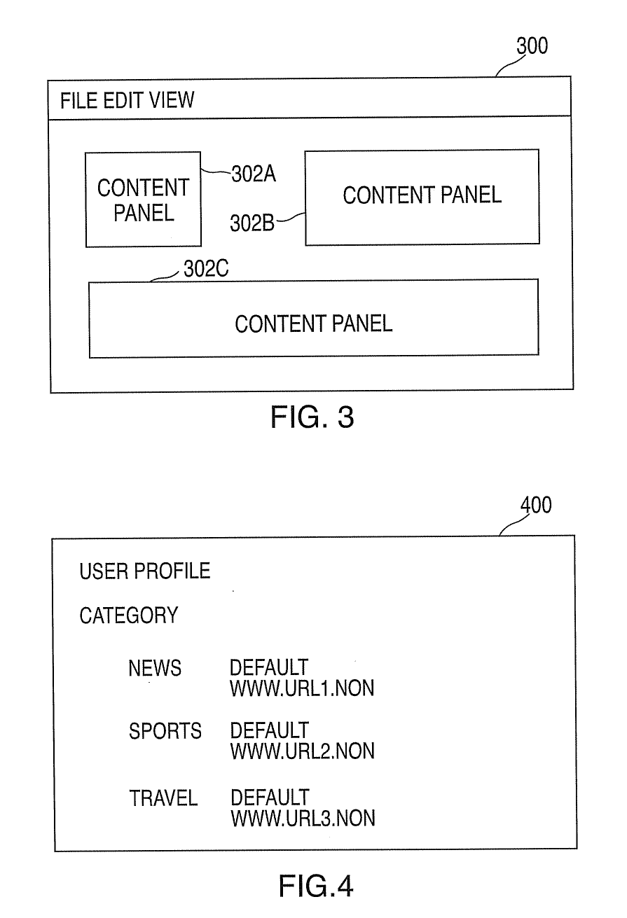

Turning now to FIG. 2, a process for implementing the preferred content services will now be described in exemplary embodiments. The process described in FIG. 2 assumes that a user (e.g., user system 106) is a subscriber of syndicated content services provided by the host system 102, or is registering to do so. An existing subscriber has previously selected categories of content of interest (e.g., news, weather, politics, travel, etc.). Alternatively, or in addition, the user may have selected URLs of content providers for which content items are desired. In either event, the host system 102 collects content items (and associated URL links) from corresponding content sources 104 and presents the items within panels that are customized for the user based upon his/her selections. A sample web page including content panels 302A-302C is shown in FIG. 3. This web page 300 is presented to the user system 106 via the user system's 106 Web browser 114. Content panel 302A, e.g., may provide content items for a selected category ‘News’, while content panel 302B relates to a selected category ‘Sports’ and content panel 302C relates to a selected category ‘Travel’.

The media source application 112 prompts the user to create a profile containing preferred content providers in the event repetitious content items from various content sources are detected. A sample user interface 400 for creating a profile is shown in FIG. 4. In this example, the user has selected a URL for the category, ‘News’. The user has also selected a URL for the category, ‘Sports’, and another URL for the category, ‘Travel’.

At step 202, the host system 102 receives the selections from the user and creates a profile that is stored in storage device 112. The selections each relate to a selected category of content.

At step 204, the media source application 110 analyzes the content from content feeds to identify similarities within content items. The analysis may include searching for key words that are commonly occurring among the content items analyzed. The analysis may further include weighting the key words found by one or more of: the location of the key word in the content item, the frequency of occurrence of the key word in the content item, the currency of the content item (e.g., date posted or published), etc. Based upon this analysis, the media source application 110 determines whether two or more content items are similar enough to be considered repetitive (e.g., whether a threshold level of similarities is met). The media source application 110 also identifies the category to which the content item belongs. A story about an athlete may be found in content feeds that originate from many different content sources.

At step 206, it is determined whether the content items analyzed are repetitions (i.e., threshold level of similarities). If not, each of the content items is presented to the user system 106 within respective content panels at step 208. Otherwise, the media source application 110 retrieves the profile of the user system 106 to determine whether any preferred content providers were selected for the category associated with the repetitive content items at step 210. If none was selected, the media source application 110 utilizes a default setting which selects the content item from the content provider that is most frequently accessed by the user system for distribution at step 212. Otherwise, the media source application 110 presents the content item associated with the preferred content provider and the identified category within the respective content panel at step 214.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may male various improvements and enhancements which fall within the scope of the claims which follow. These claims should be construed to maintain the proper protection for the invention first described.

What is claimed is:

1. A method for providing preferred media sources of content, comprising:
receiving a profile of preferred content providers and corresponding uniform resource locators (URLs), each of the preferred content providers selected for a category of content, the preferred content providers selected from a group of content providers that provide syndicated content to subscribing entities, the profile created by one of the subscribing entities;
analyzing content feeds from the group of content providers to identify similarities in content items and to identify the categories to which each of the content items belong;
determining from the profile a preferred content provider for the category identified in response to the analyzing when a threshold level of similarities among two or more of the content items are found; and
presenting the content item, which is associated with the preferred content provider and the identified category, to the subscribing entity.

2. The method of claim 1, wherein the content providers provide content items via at least one of a:
personal web page;
Weblog site;
podcast;
video log; and
mass media website.

3. The method of claim 1, wherein identifying similarities in content items is performed by comparing key words located in the content items and weighting the key words by at least one of: location of the key words in the content items, frequency of occurrence of the key words in the content items, and posting date of the content items.

4. The method of claim 1, wherein the content items include at least one of:
news articles;
personal journal entries;
photos;
music;
television programming; and
topical information.

5. The method of claim 1, wherein the categories of content items include:
news;
politics;
weather;
health;
medicine;
finance;
sports;
business;
family; and
hobbies.

6. A system for providing preferred media sources of content, comprising:
a host system; and
a media source application executing on the host system, the media source application performing a method, comprising:
receiving a profile of preferred content providers and corresponding uniform resource locators (URLs), each of the preferred content providers selected for a category of content, the preferred content providers selected from a group of content providers that provide syndicated content to subscribing entities, the profile created by one of the subscribing entities;
analyzing content feeds from the group of content providers to identify similarities in content items and to identify the categories to which each of the content items belong;
determining from the profile a preferred content provider for the category identified in response to the analyzing when a threshold level of similarities among two or more of the content items are found; and
presenting the content item, which is associated with the preferred content provider and the identified category, to the subscribing entity.

7. The system of claim 6, wherein the content providers provide content items via at least one of a:
personal web page;
Weblog site;
podcast;
video log; and
mass media website.

8. The system of claim 6, wherein identifying similarities in content items is performed by comparing key words located in the content items and weighting the key words by at least one of: location of the key words in the content items, frequency of occurrence of the key words in the content items, and posting date of the content items.

9. The system of claim 6, wherein the content items include at least one of:
news articles;
personal journal entries;
photos;
music;
television programming; and
topical information.

10. The system of claim 6, wherein the categories of content items include:
news;
politics;
weather;
health;
medicine;
finance;
sports;
business;
family; and
hobbies.
